(19) United States
(12) Patent Application Publication
(10) Pub. No.: US 2026/0285609 A1
(43) Pub. Date: Sep. 24, 2026

(54) CONVEYOR AND CONTROL DEVICE FOR THE CONVEYOR

(71) Applicant: TOYOTA JIDOSHA KABUSHIKI KAISHA, Toyota-shi (JP)

(72) Inventors: Ryohei CHINO, Nishin-shi (JP); Manabu HANDA, Toyota-shi (JP); Hiroaki NISHINO, Toyota-shi (JP); Hironaga ONO, Toyota-shi (JP); Shimpei ISOBE, Toyota-shi (JP); Yohei ONO, Nishin-shi (JP); Ritsu NISHIMURA, Nagoya-shi (JP); Manabu HIROSE, Okazaki-shi (JP)

(73) Assignee: TOYOTA JIDOSHA KABUSHIKI KAISHA, Toyota-shi (JP)

(21) Appl. No.: 19/536,409

(22) Filed: Feb. 11, 2026

(30) Foreign Application Priority Data
Mar. 18, 2025 (JP) 2025-043813

(51) Int. Cl. B65G 41/00; B65G 1/04; B65G 15/12; B65G 43/10; B65G 47/31; B66F 3/00; B66F 3/10; B66F 3/12; B66F 3/46; B66F 5/04; B66F 9/24

(52) U.S. Cl. CPC B65G 41/002; B65G 1/0492; B65G 15/12; B65G 43/10; B65G 47/31; B66F 3/005; B66F 3/10; B66F 3/12; B66F 3/46; B66F 5/04; B66F 9/24

(57) ABSTRACT

A conveyer includes: a first transport device configured to jack up and jack down a vehicle body using a first jacking point provided at a front portion of the body of the vehicle, and transport the vehicle by autonomously traveling while lifting the vehicle; and a second transport device configured to jack up and jack down the body of the vehicle using a second jacking point provided at a rear portion of the body of the vehicle, and transport the vehicle by autonomously traveling together with the first transport device while lifting the vehicle. The first transport device includes: a first clamping device and a first lift arm. The second transport machine includes: a second clamping device and a second lift arm.

The present application claims priority to and incorporates by reference the entire contents of Japanese Patent Application No. 2025-043813 filed in Japan on Mar. 18, 2025.

### BACKGROUND

The present disclosure relates to a conveyor and a control device for the conveyor.

JP2022189891A discloses a vehicle transport device that transports a vehicle using multiple robots, wherein each robot enters under the vehicle, with the first robot lifting the vehicle's front wheels and the second robot lifting the vehicle's rear wheels during transport.

### SUMMARY

In the configuration described in JP2022189891A, when the robots lift the wheels, the horizontally operating lift arms press against the tire tread surface. This causes a large load to be applied to the tire in the front-to-back direction, pinching it between the robots. Therefore, if the tire is deflated or has wear or damage on the tread surface, there is a risk of tire damage when the robot clamps the tire in the front-to-back direction.

There is a need for a transport machine and a control device for the transport machine that are able to lift a vehicle using the vehicle's jacking points and transport the vehicle to a predetermined position while it is lifted.

According to one aspect of the present disclosure there is provided a conveyer including: a first transport device configured to jack up and jack down a body of a vehicle using a first jacking point provided at a front portion of the body of the vehicle, and transport the vehicle by autonomously traveling while lifting the vehicle; and a second transport device configured to jack up and jack down the body of the vehicle using a second jacking point provided at a rear portion of the body of the vehicle, and transport the vehicle by autonomously traveling together with the first transport device while lifting the vehicle, wherein the first transport device includes a first clamping device configured to grip the first jacking point from below the body of the vehicle, and a first lift arm configured to automatically operate to change a vertical position of the first clamping device and fix the first clamping device at a first predetermined vertical position, the first clamping device being provided at a distal end of the first lift arm, the second transport machine includes a second clamping device configured to grip the second jacking point from below the body of the vehicle, and a second lift arm configured to automatically operate to change a vertical position of the second clamping device and fix the second clamping device at a second predetermined vertical position, the second clamping device being provided at a distal end of the second lift arm, the first clamping device includes a pair of first claw members configured to abut the first jacking point from below the body of the vehicle for receiving a reaction force of load pushing up the first jacking point, and close for gripping the first jacking point, and the second clamping device includes a pair of second claw members configured to abut the second jacking point from below the body of the vehicle for receiving a reaction force of load pushing up the second jacking point, and close for gripping the second jacking point.

According to another aspect of the present disclosure, there is provided a control device for a conveyer configured to use jacking points provided on a body of vehicle to jack up or jack down the body, and transport the vehicle to a predetermined position while lifting the vehicle, the control device including: a camera installed on the conveyor and configured to capture an image of the vehicle as seen from the conveyor; and a controller configured to control the conveyor by executing jack-up control including identifying a position of the jacking point relative to the conveyer based on image data captured by the camera, controlling a clamping device of the conveyer to grip the identified jacking point, and controlling a jack of the conveyer to raise the body of the vehicle, and transport control including controlling the conveyer to automatically move while jacking up the body of vehicle to transport the vehicle to a predetermined position.

### BRIEF DESCRIPTION OF THE DRAWINGS

FIG. 1 is a perspective view showing the transport device in an embodiment;

FIG. 2 is a diagram illustrating the transport device in a stowed state;

FIG. 3 is a perspective view showing the transport device in an extended state;

FIG. 4 is a diagram illustrating the transport device in the extended state;

FIG. 5 is an illustration explaining the clamping mechanism engaging the garage jacking point from below;

FIG. 6 is an illustration explaining the state where the clamping mechanism grips the garage jacking point;

FIG. 7A is a diagram illustrating the conveyor moving beneath the vehicle body;

FIG. 7B is a diagram illustrating the conveyor positioned beneath the vehicle body;

FIG. 7C is a diagram illustrating the vehicle lifted by the conveyor;

FIG. 8 is a diagram illustrating the vehicle's underbody structure; and

FIG. 9 is a flowchart illustrating the vehicle transport control flow to the automatic charging device.

### DETAILED DESCRIPTION

The following describes in detail the conveyor and the conveyor control device in an embodiment of the present disclosure. Note that the present disclosure is not limited to the embodiments described below.

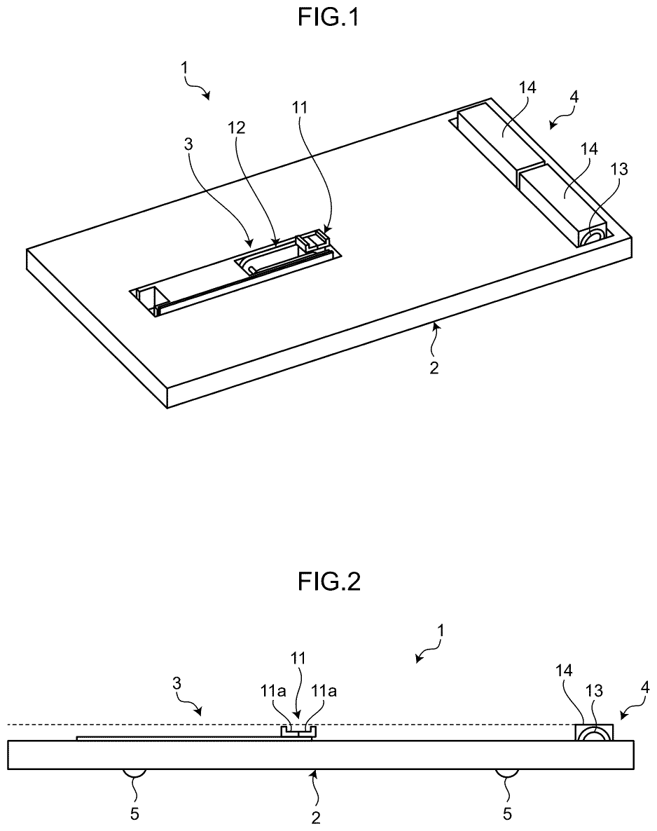

FIG. 1 is a diagram showing the transport device in an embodiment. The transport device 1 is an autonomous transport robot that transports vehicles in spaces such as parking lots. The transport device 1 is a compact transport device that lifts a vehicle using the vehicle's garage jacking points and then automatically transports the lifted vehicle to a predetermined position.

As illustrated in FIGS. 1 to 4, the transport device 1 includes a main body 2, a jack 3, a support mechanism 4, wheels 5, a control device, a camera, and a strain gauge 6.

The main body 2 is a robot body equipped with various actuators. The main body 2 is formed to a size that can fit under the vehicle body. The main body 2 is formed to be lower in height than the vehicle body. Viewed from the height direction, the main body 2 is formed into a rectangular shape. The main body 2 has its longitudinal direction in the front-rear direction and its transverse direction in the width direction, with the width direction length formed shorter than the distance between the vehicle's left and right wheels.

The jack 3 and the support mechanism 4 are provided on the upper surface of the main body 2, and wheels 5 are provided on the lower surface of the main body 2. The jack 3 is provided at the center of the width direction of the main body 2 and extends in the front-rear direction. The support mechanism 4 is provided at the rear of the main body 2 and extends in the width direction. The wheels 5 are provided at the front, rear, left, and right sides of the main body 2. The main body 2 carries a first actuator to operate the jack 3, a second actuator to operate the support mechanism 4, and a drive device to drive the wheels 5. The first actuator operates the jack 3 using hydraulic power or electric motor power. The second actuator operates the support mechanism 4 using hydraulic power or electric motor power. The drive device includes an electric motor as the power source and a power transmission mechanism that transmits the output power from the electric motor to the wheels 5. The first actuator, second actuator, and drive device are controlled by a control device.

The jack 3 automatically jacks up or jacks down the vehicle body. The jack 3 includes a clamp mechanism 11 and a lift arm 12.

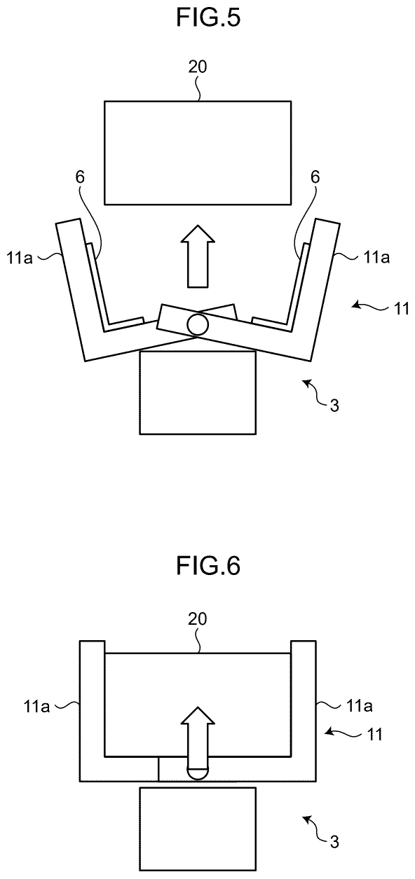

The clamping mechanism 11 is a mechanism for gripping the jacking points of the vehicle body. As illustrated in FIGS. 5 and 6, the clamping mechanism 11 has a pair of claw portions 11a for gripping the garage jacking points 20 of the vehicle body. The pair of claw sections 11a contacts the garage jacking point 20 from below and closes to grip the garage jacking point 20 by receiving the reaction force of the load exerted by the lift arm 12 pushing up the garage jacking point 20. As illustrated in FIG. 5, the pair of claw portions 11a remain open when not subjected to load from the garage jacking points 20. In the transport machine 1, the clamping mechanism 11 is provided on the jack 3 and functions to close the clamping mechanism 11 using the load pushing up the garage jacking points 20, thereby fixing the clamping mechanism 11 to the garage jacking points 20.

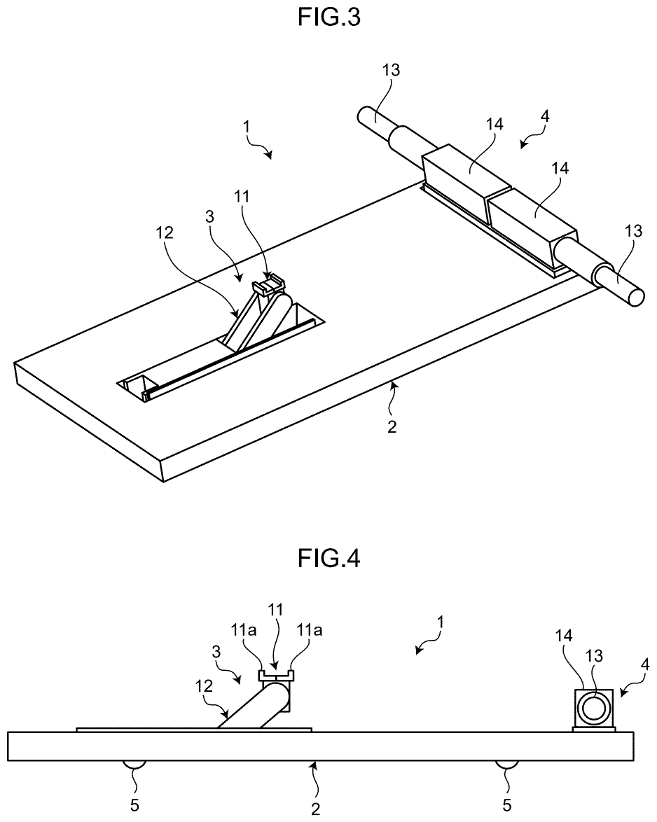

The lift arm 12 is a movable arm with a clamping mechanism 11 provided at its tip. The lift arm 12 automatically operates to displace the clamping mechanism 11 vertically, fixing the clamping mechanism 11 at predetermined vertical positions. In the jack 3, raising the lift arm 12 via the first actuator enables clamping of the garage jacking point 20 by the clamping mechanism 11. The lift arm 12 switches between a stowed state, As illustrated in FIGS. 1 and 2, where it is stored within the main body 2, and an erected state, As illustrated in FIGS. 3 and 4, where it is raised from the main body 2. The lift arm 12 is switched between the stowed state and the erected state by the first actuator.

The support mechanism 4 is a mechanism for maintaining the posture of a vehicle being transported in a horizontal position, supporting the vehicle body to prevent the lifted vehicle from falling. The support mechanism 4 includes a support member 13 and a storage section 14.

The support member 13 contacts the vehicle body's side jacking points and supports the vehicle body to restrict roll direction movement of the lifted vehicle, thereby maintaining the vehicle's horizontal posture. The support member 13 is a rod-shaped member that extends outward in the width direction of the main body 2 from the storage section 14 and can retract to a length storable within the storage section 14. The support member 13 is a member capable of horizontal extension and retraction.

The storage section 14 stores the support member 13 in its retracted state and is capable of vertical movement. The storage section 14 switches between a lowered state, where it is housed within the main body section 2 with the retracted support member 13 stored, and an elevated state, where it protrudes from the top of the main body section 2 with the extended support member 13 supported.

The support mechanism 4 switches between a stored state, As illustrated in FIGS. 1 and 2, where the support member 13 and storage unit 14 are stored within the main body 2, and an extended state, As illustrated in FIGS. 3 and 4, where the support member 13 extends beyond the width of the main body 2 from the raised storage unit 14. The support mechanism 4 switches between the stored state and the extended state via the second actuator. It is configured to suppress vehicle drop by maintaining the vehicle's load balance during transport using the clamping mechanism 11 and the support mechanism 4.

The control device includes a control unit that controls the transport machine 1. Signals from a camera mounted on the transport machine 1 and signals from the strain gauge 6 are input to the control device. The camera is installed on the upper surface of the main body 2 and captures images of the surroundings of the transport machine 1. The camera captures images of the vehicle's underbody structure as seen from the transport machine 1. The camera outputs the captured image data to the control device. The control unit identifies the position of the jacking points on the transporter 1 based on the image data captured by the camera. The control unit executes jack-up control, which involves gripping the identified jacking points with the clamping mechanism 11 and jacking up the vehicle body using the jack 3. The control unit executes a jack-down control to lower the vehicle body to the ground using the jack 3. Furthermore, the control unit executes a transport control to automatically drive the conveyor 1 while the vehicle body is jacked up by the jack 3, thereby transporting the vehicle to a predetermined position.

The strain gauge 6 is a detection unit that detects the roll angles of the left and right sides of the vehicle lifted by the transport machine 1. The strain gauge 6 is provided on the clamping mechanism 11 and the support mechanism 4 to detect the load balance of the lifted vehicle. The strain gauge 6 is provided on the claw portion 11a at the part contacting the garage jacking point 20. For example, the strain gauge 6 is provided on the bottom surface or side surface of claw portion 11a. The strain gauge 6 is provided on the support member 13 at the portion contacting the side jacking point. The strain gauge 6 is provided on the upper surface of support member 13. The control unit can determine the load balance of the vehicle being transported based on the signal input from the strain gauge 6. The transport machine 1 has the strain gauges 6 installed on each of the left and right support members 13, enabling it to detect vehicle misalignment during transport and perform emergency stops, jack-down operations, and realignment to prevent overturning. When the control unit of the transport machine 1 detects, based on signals from the strain gauges 6, that the load balance of the transported vehicle has been disrupted, it executes stop control to halt the transport operation and jack-down control. This prevents the vehicle from falling when its load balance is disrupted during transport.

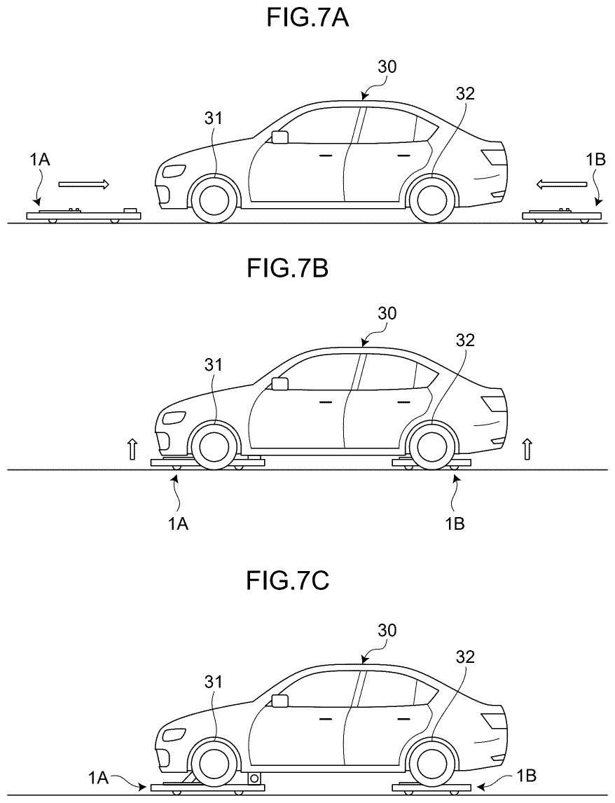

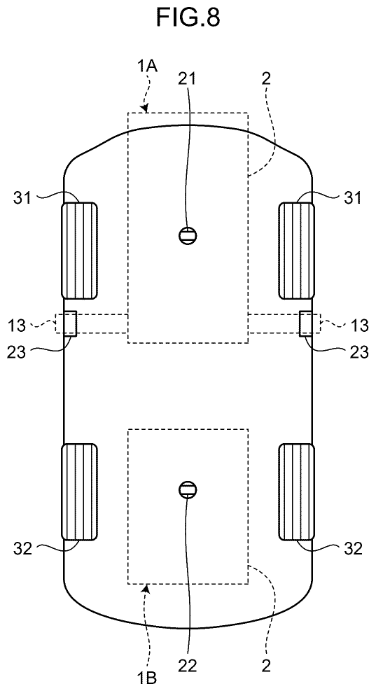

The transport device 1 configured in this manner, As illustrated in FIG. 7, enables a single vehicle 30 to be transported by multiple transport devices 1A and 1B. The multiple transport devices 1 include a first transport device 1A and a second transport device 1B. The first transport device 1A supports the vehicle body at three points: the front jacking point and the left and right side jacking points. The second conveyor 1B supports the vehicle body at a single point, the rear jacking point. Unlike the first conveyor 1A, the second conveyor 1B does not include a support mechanism 4. As illustrated in FIG. 8, the front jacking point is the first jacking point 21 provided at the front of the vehicle body, the rear jacking point is the second jacking point 22 provided at the rear of the vehicle body, and the side jacking points are the third jacking points 23 provided on both left and right sides of the vehicle body. The first jacking point 21 is positioned at the center in the vehicle width direction and at a position overlapping the front wheels in the vehicle fore-aft direction. The first conveyor 1A uses the first jacking point 21 to jack up or jack down the vehicle body. The first jacking point 21 is clamped by the clamping mechanism 11 of the first conveyor 1A and raised or lowered by the lift arm 12 of the first conveyor 1A. The second jacking point 22 is positioned at the center in the vehicle width direction and at a position overlapping the rear wheels in the vehicle fore-aft direction. The second conveyor 1B uses the second jacking point 22 to jack up or jack down the vehicle body. The second jacking point 22 is clamped by the clamping mechanism 11 of the second conveyor 1B and raised or lowered by the lift arm 12 of the second conveyor 1B. The third jacking point 23 is positioned on both sides in the width direction of the vehicle and behind the front wheels in the fore-aft direction of the vehicle.

As illustrated in FIG. 7A, the first conveyor 1A enters under the vehicle body from the front of the vehicle 30 in its stowed state, and the second conveyor 1B enters under the vehicle body from the rear of the vehicle 30 in its stowed state. The control unit of the first conveyor 1A controls the drive device to enter under the vehicle body and identifies the position of the first jacking point 21 based on image data captured by a camera at the lower position of the vehicle body. The control unit of the second transport device 1B controls the drive device to move under the vehicle body and identifies the position of the second jacking point 22 based on image data captured by a camera at the lower position of the vehicle body.

As illustrated in FIG. 7B, the control unit of the first transport device 1A automatically actuates the lift arm 12 to bring the clamping mechanism 11 into contact with the first jacking point 21 from beneath the vehicle body. At this time, the pair of claw portions 11a of the first conveyor 1A close to grasp the first jacking point 21 by receiving the reaction force of the load pushing up the first jacking point 21. The control unit of the second conveyor 1B automatically actuates the lift arm 12, bringing the clamping mechanism 11 into contact with the second jacking point 22 from below the vehicle body. At this time, the pair of claw sections 11a of the second conveyor 1B close to grip the second jacking point 22 by receiving the reaction force of the load pushing up the second jacking point 22.

As illustrated in FIG. 7C, the control unit of the first transport machine 1A executes the first jack-up control, causing the jack 3 of the first transport machine 1A to jack up the first jacking point 21 to lift the vehicle 30 until the front wheel 31 is raised off the ground. Furthermore, after executing the first jack-up control, the control unit of the first conveyor 1A executes a support control. This involves bringing the support member 13 of the first conveyor 1A into contact with the vehicle body from below at a pair of third jacking points 23 to support the vehicle body. The control unit of the first transport machine 1A executes the support control starting from a state where the first jacking point 21 has been pushed up to a height where the third jacking points 23 do not contact the support member 13. The support control includes an extension control that switches the support mechanism 4 from a retracted state to an extended state, and a contact control that displaces the height position of the clamp mechanism 11 downward. When executing support control, the control unit of the first transport machine 1A first executes the deployment control, followed by the contact control. After switching the support mechanism 4 from the retracted state to the extended state, the control unit of the first transport machine 1A displaces the height position of the clamping mechanism 11 downward to contact the pair of third jacking points 23 with the upper surface of the support member 13. The support member 13 supports the vehicle body to maintain the vehicle 30's posture horizontally by receiving the load from the third jacking points 23. The support member 13 receives the load from the third jacking points 23 while the claw portion 11a of the first transporter 1A is gripping the first jacking points 21.

After the support control by the first conveyor 1A is completed, the control unit of the second conveyor 1B executes the second jack-up control, causing the jack 3 of the second conveyor 1B to jack up the second jacking point 22 to lift the vehicle 30 until the rear wheel 32 is raised. The control unit of the second conveyor 1B executes the second jack-up control after the control unit of the first conveyor 1A has executed the first jack-up control and the support control. That is, when executing the second jack-up control, the vehicle body is supported at three points by the first conveyor 1A.

The control units of the first transport vehicle 1A and the second transport vehicle 1B execute transport control to move the vehicle 30 to a predetermined position while it is lifted by the first transport vehicle 1A and the second transport vehicle 1B, with the front wheels 31 and rear wheels 32 off the ground. The first transport vehicle 1A autonomously travels while carrying the lifted vehicle 30. The second transport unit 1B transports the vehicle 30 by autonomously traveling while lifting it together with the first transport unit 1A. The control units of the first transport unit 1A and the second transport unit 1B coordinate to transport the vehicle 30 to the predetermined position. During transport of the vehicle 30, the first transport unit 1A and the second transport unit 1B perform coordinated operations. The control unit of the first transport unit 1A and the control unit of the second transport unit 1B transport the vehicle 30 based on a predetermined transport path.

During transport, the load applied from vehicle 30 to first conveyor 1A is detected to prevent vehicle 30 from falling. The control unit of the first conveyor 1A determines the load balance of the vehicle 30 based on signals from the strain gauge 6 installed on the first conveyor 1A. The control unit of the first conveyor 1A continues the conveying operation of the first conveyor 1A when the load balance is within the allowable value, and stops the conveying operation of the first conveyor 1A when the load balance deviates from the allowable value. The control unit of the second conveyor 1B continues the conveying operation of the second conveyor 1B when the conveying operation of the first conveyor 1A continues, and stops the conveying operation of the second conveyor 1B when the conveying operation of the first conveyor 1A stops. The control unit of the first conveyor 1A and the control unit of the second conveyor 1B execute a jack-down control to lower the vehicle 30 to the ground at the stop position when the conveying operation is stopped due to the load balance of the vehicle 30 being disrupted. The control unit of the first conveyor 1A and the control unit of the second conveyor 1B execute a jack-down control to lower the vehicle 30 to the ground at the predetermined position when the conveyance of the vehicle 30 to the predetermined position is completed with the load balance of the vehicle 30 remaining within the allowable value while the conveyance operation continues.

The transport device 1 configured in this manner can transport a parked vehicle 30, which is located away from an automatic charging device within a parking lot, to a position near the automatic charging device for automatic charging by the device. This vehicle 30 is an electric vehicle, such as a plug-in hybrid electric vehicle or a battery electric vehicle. In this case, multiple transporters 1 can coordinate their operation to transport the electric vehicle. During transport, coordinated operation by multiple transporters 1 is performed, and the system is configured to detect the load applied from the electric vehicle to the transporter 1 to prevent the electric vehicle from falling.

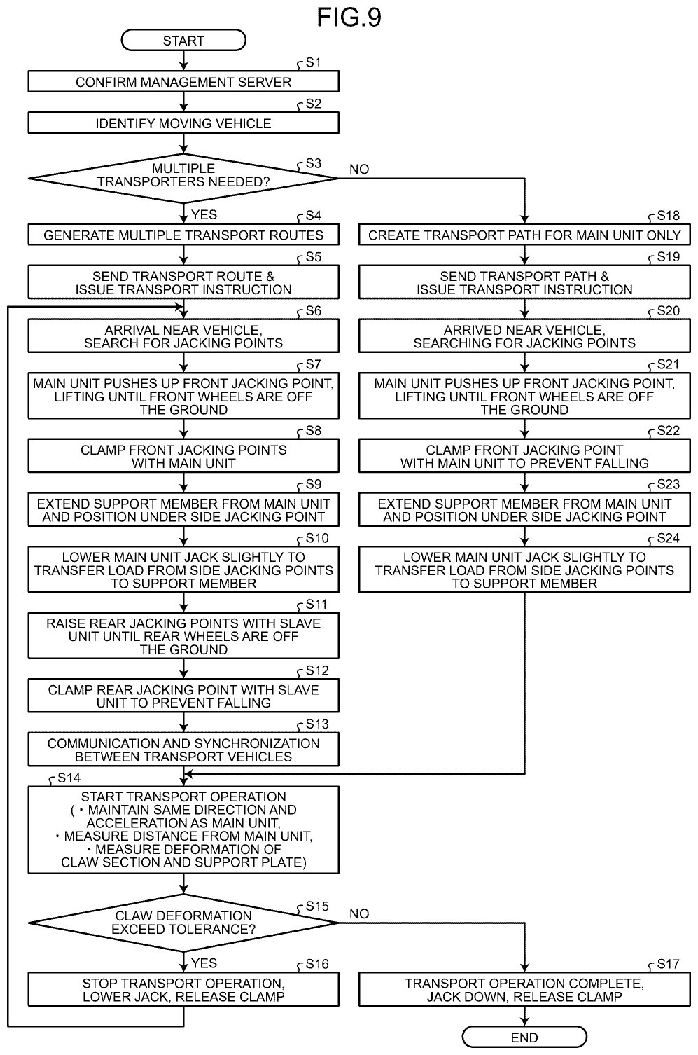

FIG. 9 is a flowchart illustrating the vehicle transport control flow to the automatic charging device. The control illustrated in FIG. 9 is performed by the control device of the transport unit 1. The control device of the transport unit 1 includes a control device for the first transport unit 1A, a control device for the second transport unit 1B, and a control device provided in the management device that manages the plural transport units 1. The management device is capable of outputting command signals to the transport unit 1 via wireless communication with the transport unit 1.

The control device of the management device checks information stored in the management server (Step S1). The management server includes a first management server that manages automatic charging reservation status and electric vehicle entry status, and a second management server that manages automatic charging schedules. The management device acquires various information stored in the management server through communication with the management server.

The control device of the management device identifies the vehicle 30 to be moved from now based on the information confirmed in Step S1 (Step S2). The control device identifies the vehicle 30 to be moved to a predetermined position using the transport device 1 by confirming the scheduled start time and scheduled end time of transport.

The control device of the management device determines whether multiple conveyors 1 are required (Step S3). The control device determines whether the vehicle 30 is an all-wheel drive (AWD) vehicle. If vehicle 30 is an all-wheel drive vehicle, Step S3 yields an affirmative determination; if vehicle 30 is not an all-wheel drive vehicle, Step S3 yields a negative determination. If vehicle 30 is a front-wheel drive vehicle (FWD) or a rear-wheel drive vehicle (RWD), Step S3 yields a negative determination.

If it is determined that multiple conveyors 1 are required (Step S3: Yes), the control device of the management device generates multiple conveyance routes (Step S4) and transmits the conveyance routes to the multiple conveyors 1 to instruct conveyance (Step S5). This control device generates a transport route between a main unit, the first transport machine 1A, and a child unit, the second transport machine 1B, and transmits the transport route and transport instructions to the first transport machine 1A and the second transport machine 1B.

The control device of the first transport machine 1A and the control device of the second transport machine 1B cause the first transport machine 1A and the second transport machine 1B to arrive near the vehicle 30 based on the received transport command and search for the jacking points (Step S6).

The control device of the first transport machine 1A raises the vehicle body by having the jack 3 push up the front jacking point until the front wheel 31 of the vehicle 30 lifts off the ground (Step S7), and then clamps the front jacking point using the clamp mechanism 11 (Step S8).

The control device of the first conveyor 1A extends the support member 13 from the storage section 14 and positions the support member 13 beneath the side jacking point (Step S9).

The control device of the first conveyor 1A operates the lift arm 12 to slightly lower the height position of the clamping mechanism 11 of the jack 3, thereby receiving the load from the side jacking point via the support member 13 (Step S10).

The control device of the second conveyor 1B raises the vehicle body by having the jack 3 push up the rear jacking point until the rear wheel 32 of the vehicle 30 lifts off the ground (Step S11), and then clamps the rear jack using the clamping mechanism 11 (Step S12).

The control device of the first conveyor 1A and the control device of the second conveyor 1B communicate and synchronize with each other (Step S13).

The control device of the first conveyor 1A and the control device of the second conveyor 1B initiate the vehicle 30 transport operation by the first conveyor 1A and the second conveyor 1B (Step S14).

The control device of the first conveyor 1A determines whether the strain of the claw portion 11a or the strain of the support member 13 has exceeded the allowable value (Step S15). The strain of the claw portion 11a and the strain of the support member 13 are detected based on the strain gauge 6 provided on the claw portion 11a and the strain gauge 6 provided on the support member 13.

If it is determined that the strain of the claw portion 11a or the strain of the support member 13 has exceeded the allowable value (Step S15: Yes), the control device of the first conveyor 1A stops the conveying operation, performs jack-down, and releases the clamp (Step S16). Both the first transport device 1A and the second transport device 1B perform the transport operation stop, jack down, and clamp release. After executing the processing of Step S16, this control routine returns to Step S6.

If it is determined that the distortion of the claw portion 11a or the distortion of the support member 13 does not exceed the allowable value (Step S15: No), the control device of the first conveyor 1A and the control device of the second conveyor 1B continue the conveying operation, complete the conveying operation to the predetermined position, and perform jacking down and clamp release at the predetermined position (Step S17). Upon executing the processing of Step S17, this control routine terminates.

If it is determined that multiple conveyors 1 are not necessary (Step S3: No), the control device of the management device generates a transport path only for the main unit, the first conveyor 1A (Step S18), and transmits the transport path to the first conveyor 1A to instruct it to transport the vehicle 30 (Step S19). The processing in Steps S20 to S24 is the same as the processing in Steps S6 to S10. Upon executing the processing in Step S24, this control routine proceeds to Step S14.

As described above, according to the embodiment, the conveyor 1 can lift the vehicle 30 using the vehicle body's garage jacking points 20 and transport the vehicle 30 to a predetermined position while it is lifted. This enables stable lifting and transport of the vehicle 30 without damaging its tires.

In this disclosure, the vehicle can be lifted using the vehicle body's jacking points and transported to a predetermined position while the vehicle is lifted.

The second transport machine 1B may have a structure similar to that of the first transport machine 1A. Furthermore, the support member 13 is not limited to a rod-shaped member and may also be a plate-shaped member. Additionally, the vehicle 30 is not limited to battery electric vehicles or plug-in hybrid vehicles but may also be an engine vehicle or a hybrid electric vehicle.

Although the disclosure has been described with respect to the specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A conveyer comprising:
a first transport device configured to
jack up and jack down a body of a vehicle using a first jacking point provided at a front portion of the body of the vehicle, and
transport the vehicle by autonomously traveling while lifting the vehicle; and
a second transport device configured to
jack up and jack down the body of the vehicle using a second jacking point provided at a rear portion of the body of the vehicle, and
transport the vehicle by autonomously traveling together with the first transport device while lifting the vehicle,
wherein the first transport device includes
a first clamping device configured to grip the first jacking point from below the body of the vehicle, and
a first lift arm configured to automatically operate to change a vertical position of the first clamping device and fix the first clamping device at a first predetermined vertical position, the first clamping device being provided at a distal end of the first lift arm,
the second transport machine includes
a second clamping device configured to grip the second jacking point from below the body of the vehicle, and
a second lift arm configured to automatically operate to change a vertical position of the second clamping device and fix the second clamping device at a second predetermined vertical position, the second clamping device being provided at a distal end of the second lift arm,
the first clamping device includes a pair of first claw members configured to
abut the first jacking point from below the body of the vehicle for receiving a reaction force of load pushing up the first jacking point, and
close for gripping the first jacking point, and
the second clamping device includes a pair of second claw members configured to
abut the second jacking point from below the body of the vehicle for receiving a reaction force of load pushing up the second jacking point, and
close for gripping the second jacking point.

2. The conveyer according to claim 1, wherein
the first transport device includes a support member configured to abut a pair of third jacking points provided on a left and right sides of the body of the vehicle from below the body of the vehicle and support the body of the vehicle to maintain a posture of the vehicle horizontally, and
the support member is configured to receive a load from the third jacking points while the first claw members are gripping the first jacking points.

3. A control device for a conveyer configured to use jacking points provided on a body of vehicle to jack up or jack down the body, and transport the vehicle to a predetermined position while lifting the vehicle, the control device comprising:
a camera installed on the conveyor and configured to capture an image of the vehicle as seen from the conveyor; and
a controller configured to control the conveyor by executing
jack-up control including
identifying a position of the jacking point relative to the conveyer based on image data captured by the camera,
controlling a clamping device of the conveyer to grip the identified jacking point, and
controlling a jack of the conveyer to raise the body of the vehicle, and
transport control including controlling the conveyer to automatically move while jacking up the body of vehicle to transport the vehicle to a predetermined position.

4. The control device according to claim 3, wherein
the conveyer includes a first transport device and a second transport device,
the jack-up control includes
first jack-up control including controlling a jack of the first transport device to jack up the body of the vehicle using first jacking points provided at a front portion of the body of the vehicle until front wheels of the vehicle are lifted off ground, and
second jack-up control including j controlling a jack of the second transport device to jack up the body of the vehicle using second jacking points provided at a rear portion of the body of the vehicle until rear wheels of the vehicle are lifted off ground, and
the transport control is executed while the first transport device and the second transport device are jacking up the body of vehicle.

5. The control device according to claim 3, wherein the control unit is configured to execute support control after executing the first jack-up control, the support control including controlling a support member provided on the first transport device to abut a pair of third jacking points provided on a left and right sides of the body of the vehicle from below the vehicle to support the body of the vehicle.
